(19) United States
(12) Patent Application Publication
(10) Pub. No.: US 2026/0298861 A1
(43) Pub. Date: Oct. 1, 2026

(54) A SYSTEM FOR DETERMINING AN INTEGRITY OF TUBE-FEED PACKAGING

(71) Applicant: SOCIÉTÉ DES PRODUITS NESTLÉ S.A., Vevey (CH)

(72) Inventor: Vladimir ZHBANKO, Goldiwil (CH)

(21) Appl. No.: 19/477,709

(22) PCT Filed: Apr. 25, 2024
(86) PCT No.: PCT/EP2024/061389

§ 371 Date: Oct. 22, 2025

(30) Foreign Application Priority Data
Apr. 28, 2023 (EP) 23170876.9

(51) Int. Cl. G01N 27/24; B65B 9/20; B65B 57/04

(52) U.S. Cl. CPC G01N 27/24; B65B 9/20; B65B 57/04

(57) ABSTRACT

A system for formation of tube-feed packaging, the system comprising: a tube feed machine for execution of a formation process, in which a tube of packaging material is fed along a filling pipe of the machine and is repetitively processed into individual packaging units, and; a detection system comprising a sensor system arranged to detect a predetermined condition associated with tube integrity as the tube is fed along the filling pipe.

### TECHNICAL FIELD

The present disclosure relates generally to systems for repetitive formation of packaging units that are formed from tube-fed packaging material, and which package food products, and to integrity testing of said packing units.

### BACKGROUND

Systems for repetitive formation of packaging units comprise a tube-feed machine for formation of packaging from sheet material. The tube-feed machine implements the steps of: forming the sheet material into a tube of packaging material around a filling pipe, and longitudinally sealing the tube; filling, via the filling pipe, the tube with a food product, and; sequentially laterally sealing the tube to form the packaging units. An example of such a machine is provided in EP0882651A1.

A drawback of such systems is that an integrity of the tube may be compromised, which may cause compromised integrity of the packaging units.

Therefore, in spite of the effort already invested in the development of said systems further improvements are desirable.

### SUMMARY

The present disclosure provides a system for formation of tube-feed packaging, the system comprising: a tube feed machine for execution of a formation process, in which a tube of packaging material is fed along a filling pipe of the machine and is repetitively processed into individual packaging units, and; a detection system comprising a sensor system arranged to detect a predetermined condition associated with tube integrity as the tube is fed along the filling pipe. In a preferred embodiment the sensor system is arranged to extend around a circumference of at least an eighth of an exterior portion of said tube, and the sensor system implements capacitive sensing.

By implementing the sensor system to determine an integrity condition of the tube whilst it is present on the filling pipe, it may be ensured that conditions of compromised tube integrity are accurately identified. By identifying compromised tube integrity (e.g. pre-formation of a packaging units), compromised packaging units may be identified or prevented from being formed. Preventive action, e.g. to reduce further compromised packages, may also be taken.

Moreover, by identifying compromised tube integrity whilst the tube is being fed, relative motion between the fed tube and the sensor system ensures that a large portion of the tube is tested by the sensor system, hence having a large array of sensors for the sensor system that span a packaging unit may be obviated.

As used herein the term “fed along” in respect of the tube and filling pipe may refer to the tube moving relative the filling pipe in a longitudinal direction of the tube, including with at least part of the tube sleeved by the filling pipe.

As used herein the term “repetitively processed” may refer to the successive execution of operations on the tube/sheet material to form the packaging units.

As used herein the term “predetermined condition associated with tube integrity” may refer to a structural formation in the tube (e.g. the material or at a seam), which is detrimental to sealing of the tube, and/or a condition associated with contamination of the tube.

As used herein the term “as the tube is fed along” in respect of the detecting the predetermined condition may refer to implementing the sensor system to detect whilst the tube is moving relative thereto and/or moving the tube in graduated increments and detecting at stationary points between movements.

In embodiments, the sensor system is arranged to extend around a circumference of an exterior portion of said tube. By arranging the sensor system to extend so that it senses around the circumference of the tube, a large area of the tube may be sensed by the sensor system since the tube is fed perpendicular to said circumferential extension, a continuous strip the circumferential width of said extension is sensed. The sensor system may be positioned over a portion of the tube so that it also fully or partially overlaps the filling tube or may be distal therefrom.

In embodiments, the sensor system extends around at least an eighth of a circumference of the tube. The sensing system may have a have a circumferential width of at least a twentieth or a sixteenth or an eighth or a quarter or half of the tube. The sensing system may extend up to less than a quarter or a half or three quarters of the tube circumference, including in combination with any of the aforesaid minimum extensions. In this way, a substantially sized strip of the tube can be sensed. The sensing system may extend fully around the tube.

In embodiments, the sensor system is curved to correspond to a shape of the tube. By implementing the sensor system to match a shape of the tube on the feeding pipe, accurate sensing of a large portion of the tube may be achieved.

In embodiments, the sensor system extends contiguous the tube. By arranging the sensor system to extend contiguous to the tube accurate sensing of the tube may be achieved, without contamination or damage of the sensor system or tube via contact.

As used herein the term “contiguous” in respect of the tube and sensor system, may refer to a normal separation distance in close proximity to without touching. The normal distance may have a minimum of 0.25 mm or 0.5 mm. The normal distance may have a maximum of 4 mm or 6 mm. and greater than 0.5 mm. Said normal distance may occur with the tube under normal conditions and therefore not subject to an integrity breach.

It can be seen from the FIG. 8, how the signal is changing in relation to the sensing distance to the object. Specifically, the output value from the sensor is negatively correlated to the distance with the curve become almost flat after 6 millimetres separation from the moving object. FIG. 8 is demonstrating that the invention provides sufficient sensitivity and working range

In embodiments, the sensor system is arranged to overlap one or more longitudinal seams of the tube of packaging material on the filling pipe. By arranging the sensor system to fully or partially overlap (e.g. extend over so that said area is sensed by the sensor) a longitudinal seam of the tube, a portion of the tube which is particularly vulnerable to integrity failure may be tested. An entirety of the seam may be overlapped.

In embodiments, the sensor system implements an electrode arrangement, which is arranged to emit a sensing field over the tube. By emitting a field over the tube continuous sensing over an area of the field may be implemented based on the field being effecting by tube integrity. In embodiments, the electrode arrangement includes a continuous sensing surface. By implement an electrode arrangement which is uniform, e.g. rather that as a plurality of discrete units, the electrode may by convenient to clean.

As used herein the term “sensing field” may refer to an sensor field that is emitted by the electrode arrangement, examples include an: electrical field; an electrostatic field; a electromagnetic field.

In embodiments, the detection system comprises electrical circuitry to determine the predetermined condition associated tube integrity from an electrical quantity related to a change in the sensing field caused by the tube. The electrical quantity may be any variable effected by a change in the field, e.g. through a circuit comprising/electrically connected to the electrode arrangement. For example a voltage; current; frequency.

In embodiments, the predetermined condition from the electrical quantity is determined based on said electrical quantity crossing one or more thresholds. For example, a first threshold for a discontinuity and a second threshold for a contaminant. A time duration threshold may also be implemented to distinguish between conditions.

In embodiments, the sensor system implements capacitive sensing. For example, an open plate capacitive sensor.

In embodiments, the detection system comprises a mounting assembly arranged to mount the sensor system in operative proximity to a tube supported by the filling pipe. As used herein the term “operative proximity” may refer to the sensor system being positioned in some manner that is suitable for sensing of the predetermined condition associated with tube integrity. It may include the contiguous positioning of the sensing system as defined herein. In embodiments, the mounting assembly is connectable to the tube feed machine.

In embodiments, the predetermined condition associated with tube integrity comprises one or more of: a degree of tightness of the tube over the filling pipe (e.g. a degree of gap between the tube and the filling pipe, including a normal distance); a discontinuity (e.g. a rupture, void or delamination) in the material of the tube or a longitudinal seam of the tube, and; a determination of a contaminant (e.g. a food product or dust or moisture) on the tube.

In embodiments, the electrical circuitry is configured to determine said predetermined condition and in response implement one or more of: a notification to a user interface of the system; prevent feeding of the tube relative the filling pipe, and; apply an agent to the tube. As used herein the term “agent” may refer to the application of a substance to attenuate contamination, e.g. steam and/or address the compromised tube integrity e.g. glue.

The present disclosure provides a packaging unit formed from the system of any preceding embodiment or another embodiment disclosed herein.

The present disclosure provides a detection system comprising a sensor system and a mounting assembly for connection to the tube-feed machine of any preceding embodiment or another embodiment disclosed herein.

The present disclosure provides a method of determining integrity of a tube of a tube-feed packaging system. The method may implement the features of any preceding embodiment or another embodiment disclosed herein.

In embodiments, the method comprises: implementing a tube of packaging material to move along a filling pipe, and; detecting with the tube on the filling pipe a predetermined condition associated tube integrity.

The present disclosure provides electrical circuitry (e.g. as a gate array) to implement the method of the preceding embodiments or another embodiment disclosed herein.

The present disclosure provides a computer readable medium comprising program code, which may be executable on one or more processors (e.g. of the system/electrical circuitry), to implement the method of any preceding embodiment or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for formation of tube-feed packaging.

FIG. 2 is an illustrative diagram showing an embodiment tube-feed machine of the system of FIG. 1.

FIG. 3 is an illustrative diagram showing an embodiment tube-feed machine and detection system of the system of FIG. 1.

FIG. 4 is an illustrative diagram showing an embodiment detection system of the system of FIG. 1.

FIGS. 5A-5C are illustrative diagrams showing an embodiment detection system and various tube conditions of the system of FIG. 1.

FIGS. 6A-6D are graphical diagrams showing an output signal from an embodiment sensor system of the detection system for various tube conditions of the system of FIG. 1.

FIG. 7 is an flow diagram showing an embodiment process of the detection system of the system of FIG. 1.

FIG. 8 is a diagram showing experiment that is demonstrates sufficient sensitivity and working range of the present invention.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein the term “system for formation of tube-feed packaging” may refer to an arrangement that includes hardware comprising a tube-feed machine for repetitively executing a formation process in a predefined manner for the formation of packaging units from sheet material. The system may implement only the tube-feed machine, or additional machines, which may form part of a manufacturing line, which can include one or more of a printing machine; gluing machine; a sheet material formation machine. The tube-feed machine may also implement any of the aforesaid machine processes.

As used herein the term “tube-feed machine” may refer to a hardware arrangement for execution of a formation process for full or partial formation of packaging units from a tube of packaging material. The machine may implement the steps of one or more of: forming the sheet material into a tube of packaging material around a filling pipe; longitudinally sealing the tube; filling, via the filling pipe, the tube with a food product, and; laterally sealing the tube to form the packaging units. The machine may implement various integrated or separate stations for implementing said steps. Other steps may also be implemented, for example: cutting of the packaging units in to discrete units; sterilization of the sheet material, e.g. by UV and/or an aseptic substance.

As used herein the term “formation process” may refer to a process executed by the tube-feed machine on the sheet material to at least partially form the packaging unit.

As used herein the term “tube” in respect of the packaging material may refer to a generally hollow member that is elongate along a longitudinal axis. The tube can be of any suitable form, e.g. tubular or other elliptical shape. The tube maybe sealed at one or more longitudinally extending seals, e.g. formed from one or more portions of sheet material. The tube may be continuous, e.g. so as to be formed continuously from a roll of sheet material.

As used herein the term “sheet material” may refer to a material arrangement with a comparatively thin thickness and a large in-plane length and width. The sheet material may be supplied as individual sheets or as a continuous web, e.g. on a roll. The sheet material may comprise a layer of fibre-based material such as paper or fibre board or a metal based material including aluminium foil, which is covered on each side with a plastics material such as polyethylene. In order to manufacture aseptic packaging units, one face of the polyethylene coated paperboard may be coated with a barrier material such as aluminium or a synthetic barrier material, which in turn is coated with a plastics material. The sheet material when formed into the tube may be referred to as packaging material.

As used herein the term “tube-feed packaging” may refer to packaging formed from the tube with the tube-feed machine as defined herein. As used herein the term “packaging unit” may refer to a single unit for containing a food product. The packaging unit may be connected to other packaging units as part of a strip or as individual items. The packaging may also be referred to as aseptic packaging.

As used herein the term “food product” may refer to liquid or pourable food products, including wine, milk, tomato puree, edible oils, fruit juices, cream, water, tea, mayonnaise etc., and including sterile treated products such as U.H.T milk.

As used herein the term “filling pipe” may refer to an arrangement for filling the tube with food product. The filling pipe may sleeve the tube.

As used herein the term “system electrical circuitry” may refer to electrical circuitry that comprises machine control electrical circuitry and/or detection system electrical circuitry, hence any of the aforesaid may be referred to more generally as electrical circuitry. The system electrical circuitry can be distributed on one or more components of the system.

As used herein the term “machine control electrical circuitry” may refer to electrical circuitry for control of the tube-feed machine to execute the formation process. The machine control electrical circuitry may fully or partially control the tube-feed machine, e.g. with partial manual control. The machine control electrical circuity can be arranged as part of the tube-feed machine or distributed on one or more components of the system.

As used herein, the term “electrical circuitry” or “circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at one component of the system, or distributed between a plurality of components of the system which are in communication with each other over a computer network via communication resources.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board or distributed as part of the system. As used herein, any machine executable instructions, or computer readable media, may be configured to cause a disclosed method to be carried out, e.g. by the system or components thereof as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The tube-feed machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet; personal area networks (PANs), including with Bluetooth a short-range wireless technology standard.

As used herein, the term “external device” or “external electronic device” or “peripheral device” may include electronic components external to the tube-feed machine, e.g. arranged at a same location or remote therefrom, which communicate therewith over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to tube-feed machine, e.g. arranged at a same location or remote therefrom, which communicate therewith over a computer network. The server system may comprise a communication interface for communication with the tube-feed machine or the external device. The server system can include: a networked-based computer (e.g. a remote server); a cloud-based computer; any other server system.

### General System Description

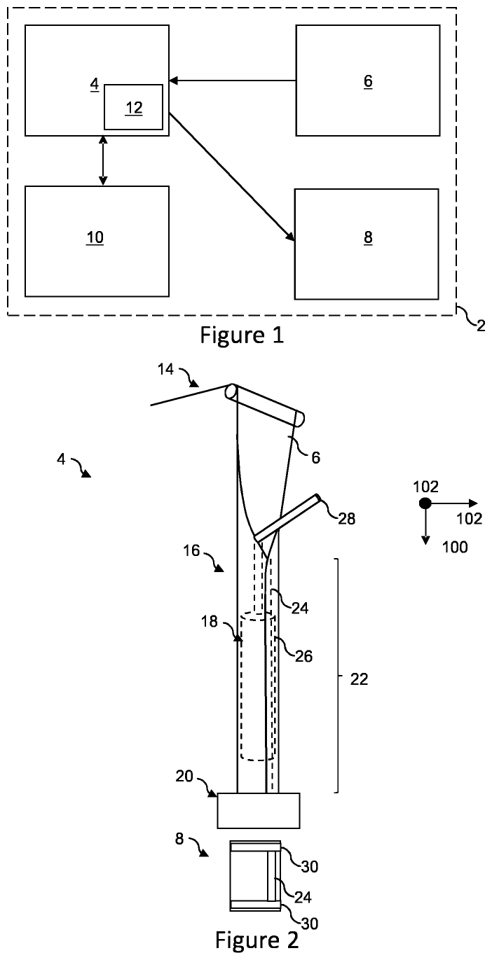

Referring to FIG. 1 a system 2 comprises: a tube-feed machine 4; sheet material 6; a packaging unit 8; electrical circuitry 10, and a detection system 12. The tube-feed machine 4 implements a formation process under the control of the electrical circuitry 10, e.g. machine control electrical circuitry, to form the packaging unit 8, from the sheet material 6 as will be discussed.

### Tube-feed Machine

Referring to FIG. 2, the tube-feed machine 4 comprises a dispensing unit 14, a tube forming arrangement 16, a filling pipe 18, and a packaging forming unit 20.

The dispensing unit 14 is arranged to dispense the sheet material 6 to the tube forming arrangement 16. The sheet material 6 may be dispensed from one or more rolls (not illustrated). The tube forming arrangement 16 manipulates sheet material into packaging material of a tube 22 and provides a longitudinal seal 24 in the tube 22, which extends in a longitudinal direction 100. The longitudinal seal 24 can be implemented by heat an/or an adhesive application systems (not illustrated) to the sheet material 6. The tube forming arrangement 16 includes an outer periphery 26 of the filling pipe 18, which acts as a guide around which the tube 22 is formed.

The filling pipe 18 transmits a food product (not illustrated) in to the tube 22. Hence a food product conduit 28 is appropriately connected to a food product transmission system (not illustrated).

The packaging forming unit 20 implements a lateral seal 30 in the tube 22, which extends in a lateral direction 102. In particular, sealing members (not illustrated) successively clamp the tube 22 at regularly spaced intervals to form the packaging units 8.

Additional detail of tube-feed machines 4 are provided in EP0882651A1.

### Detection System

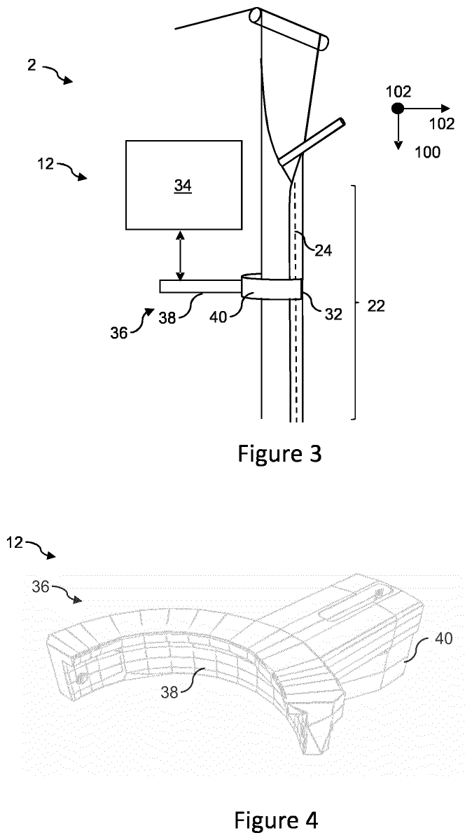

Referring to FIGS. 3 and 4, the system 2 comprises the detection system 12 to detect a predetermined condition associated with tube integrity as the tube 22 is fed along the filling pipe 18.

The detection system 2 includes a sensor system 32 to provide a signal and detection system electrical circuitry 34 to process the signal to determine the predetermined condition associated with tube integrity as the tube is fed along the filling pipe 18.

### Mounting Assembly

Referring to FIG. 4, the detection system 2 includes a mounting assembly 36 that is connected to the tube feed machine 4 so that the sensor system 32 is in operative proximity to the tube 22. The mounting assembly incudes a head 38 to hold the sensor system 32 and a body 40 for connection to the tube feed machine 4. In the alternative embodiment of the invention, not shown on the FIG. 4, the detection system 2 may comprise of a head 38 with an integrated sensor system 32. This provides the advantage of facilitated cleaning of the detection system 2.

In variant embodiments, which are not illustrated other configurations of mounting assembly are implemented, e.g. the mounting assembly connects to alternative items of the system other than the machine, e.g. a support supporting the machine.

### Sensor Arrangement

Referring to FIGS. 3 and 4, the sensor system 32 is arranged to extend around the circumference of an exterior portion of said tube 22. The extension is between a third and a quarter of the circumferential length.

In variant embodiments, which are not illustrated, other amounts of extension are implemented, e.g. at least an eighth of a circumference of the tube or a full extension around the tube.

The sensor system 32 is curved to correspond to a shape of the tube 22. The diameter of the curve is greater than the tube 22 so that the sensor system to extends contiguous but not in contact with the tube 22.

In variant embodiments, which are not illustrated, the sensor system may contact the tube, or have other formations.

The sensor system 32 is arranged to overlap the longitudinal seams 24 of the tube 22. Whilst there is only one longitudinal seam in the illustrated example, in instances where there are more than one longitudinal seams, the sensor system may span both seams or multiple sensor systems may be implemented.

### Sensor Configuration

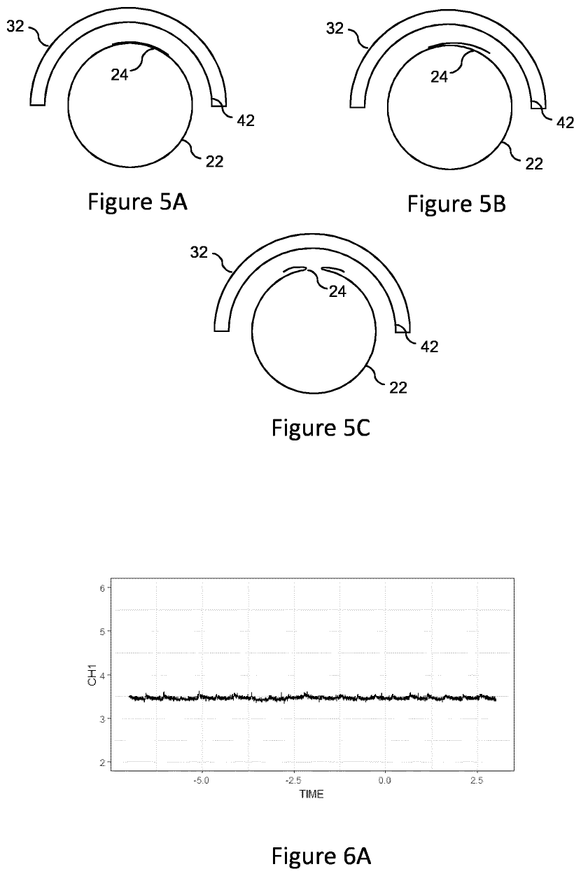

Referring to FIG. 5A, the sensor system 32 implements an electrode arrangement 42, which is arranged to emit a sensing field (not illustrated) over the tube 22. The electrode arrangement 32 is continuous over the sensor system 32.

In the example the sensing field is an electrical field to implement capacitive sensing. The electrode arrangement 42 implements an open plate capacitor.

In variant embodiments, which are not illustrated, other sensing arrangements are implemented including: other electrode arrangements e.g. as multiple discrete units; an electromagnetic field that implements inductive sensing. Other sensor system may also be implemented, e.g. a camera system with image sensing.

The sensor system 32 provides a signal from which the variable of interest can be determined (in this instance distance of the tube 22 from electrode arrangement 42, and/or dielectric property of material e.g. for contaminant detection as will be discussed). The signal is processing by the detection system electrical circuitry 34 to determine the variable of interest (including an electrical quantity related thereto). The signal is based on an alteration in the electrical field around an active zone of the field. The detection system electrical circuitry 34 implements an oscillator, demodulator, trigger stage, output driver/switching amplifier as and an RC oscillator.

The variable of interest is represented as an electrical quantity, e.g. voltage. The electrical circuitry 34 can determine the predetermined condition associated tube integrity from the voltage crossing a threshold.

In variant embodiments, depending on the sensor configuration, the electrical quantity may be a frequency of oscillation of the field, which is influence by discontinuities in the tube/contaminants; electrical current or other suitable variable. The detection system electrical circuitry may also have other appropriate implementations for providing the afore described function.

### Predetermined Condition

The predetermined condition associated with tube integrity may comprise one or more of or other condition:
1) a degree of tightness of the tube over the filling pipe (e.g. a degree of gap between the tube and the filling pipe, which may be quantified by a normal distance of the gap crossing a threshold);
2) a discontinuity (e.g. a rupture/void or delamination) in the material of the tube or a seam of the tube, and;
3) a determination of a contaminant (e.g. a food product, which may have been provided by the filling pipe and which may have leaked via a discontinuity or dust) on the tube or/including on the sensor system 32 (e.g. a peripheral surface of the electrode arrangement 42).

All of which can be identified by a change in the previously described sensing field. For example, a void or delamination is identified since there is a change in the position of the material of the tube 22 with respect to the electrode arrangement 42. A contaminant may also be identified due to a change in capacitance the contaminant causes.

Referring to FIGS. 5A-C : FIG. 5A shows the electrode arrangement 42 detecting a normal condition of acceptable tube integrity; FIG. 5B shows a discontinuity detected as a delamination in the longitudinal seam 24; FIG. 5C shows a discontinuity detected as a rupture/void in the longitudinal seam 24.

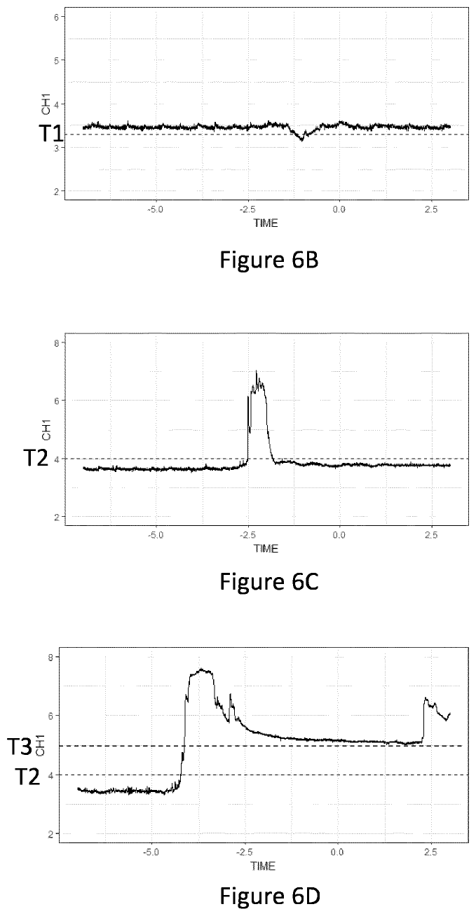

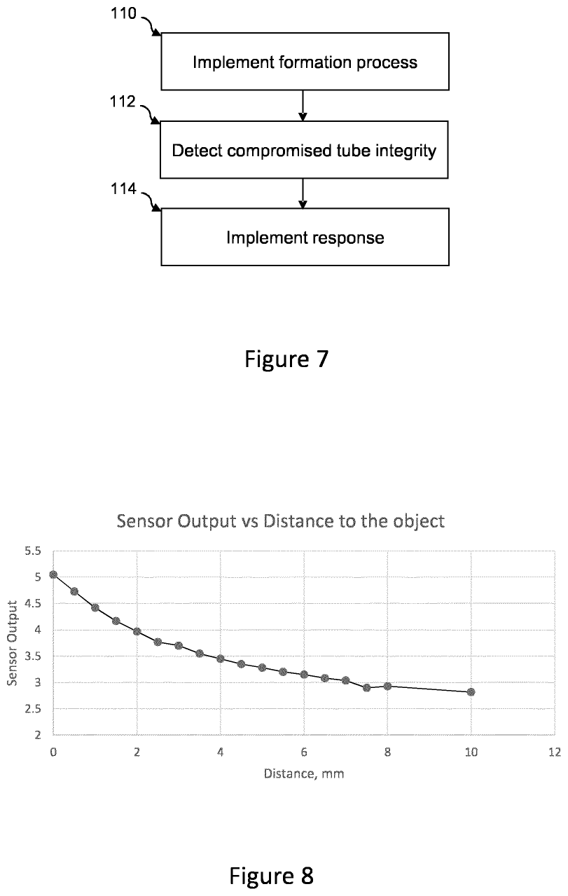

Referring to FIGS. 6A-D : various outputs of the electrical quantity (e.g. the voltage) from the sensor system 32 are illustrated against time. The electrical quantity may include some processing by the electrical circuitry 34 that may avoid false triggering and/or improved analysis (e.g. noise reduction/smoothing, which may be implemented as one or more of: a moving average; filtering; standard deviation).

FIG. 6A shows an output from the sensor system 32 for the normal condition of FIG. 5A. Since the tube 22 is arranged at a generally constant distance from the electrode arranged 42, the electrical quantity remains within a threshold magnitude.

FIG. 6B shows an output from the sensor system 32 for a condition where there is a void in the material. At the position of the void, the magnitude of the electrical quantity drops to below a first threshold T1 due to the absence of material.

FIG. 6C shows an output from the sensor system 32 for a condition where there is the longitudinal seam 24 failure condition, examples of which include the illustrations of FIG. 5B or 5C. At the position of the failure, the magnitude of the electrical quantity increases to above a second threshold T2 due to the increased proximity of the material.

FIG. 6D shows an output from the sensor system 32 for a condition where there is the longitudinal seam 24 failure condition of FIG. 5B or 5C and also a subsequent contamination of the electrode arranged 42. Due to the contamination of the electrode arranged 42 the baseline value of the electrical quantity does not return to its original value, instead its remains above by threshold T3.

It will therefore be understood that a discontinuity or contaminant may be identified by a change from a baseline in the aforesaid electrical quantity (e.g. its value) crossing a threshold, which may include the threshold being crossed for greater than a predetermined amount of time (e.g. to avoid issues with false triggering due to noise in the signal). A first and/or second threshold may be implemented for detection of discontinuities and a third threshold may be implemented for detection of a contaminant, or either may be identified by the same threshold.

A contaminant present on the electrode arrangement 42 may be identified by the electrical quantity crossing said threshold(s) and maintaining a state above said threshold(s), since discontinuity if temporary, may only temporarily effect the electrical quantity.

A different threshold may be implemented for the contaminant and for the discontinuity, e.g. a first and second threshold.

In embodiments, the electrical circuitry 34 is configured to determine said predetermined condition and in response implement one or more of:
1) a notification to a user interface of the system (not illustrated, which may be implemented by system electrical circuitry 10);
2) prevent feeding of the tube relative the filling pipe (which may be implemented by the machine electrical circuitry, e.g. by control of an actuator system that drives the tube 22 along the filling pipe 18), and;
3) the application of an agent to the tube (e.g. steam or glue, which maybe used to control a contaminant or close a rupture/void);

In other examples, the determination of the predetermined condition may be recorded on a database hence no response is implemented.

### METHOD

Referring to FIG. 6, a method of determining integrity of a tube 22 of a tube-feed packaging system 2 comprises:
Block 110: implement a formation process in which a tube 22 of packaging material moves along a filling pipe 18.
Block 112: detecting, with the detection system 12, a predetermined condition associated tube integrity.
Block 114: implementing a response to the detected predetermined condition associated tube integrity.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an', 'one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### REFERENCES

2 System
4 Tube-feed machine
14 Dispensing unit
16 Tube forming arrangement
18 Filling pipe
26 Outer periphery
28 Food product conduit
20 Packaging forming unit
6 Sheet material
22 Tube
24 Longitudinal seal
30 Lateral seal
8 Packaging unit
10 Electrical circuitry
12 Detection system
32 Sensor system
42 Electrode arrangement
34 Electrical circuitry
36 Mounting assembly
38 Head
40 Body

1. A system for formation of tube-feed packaging, the system comprising:
a tube feed machine for execution of a formation process, in which a tube of packaging material is fed along a filling pipe of the tube feed machine and is repetitively processed into individual packaging units, and
a detection system comprising a sensor system arranged to detect a predetermined condition associated with tube integrity as the tube is fed along the filling pipe, wherein the sensor system is arranged to extend around a circumference of at least an eighth of an exterior portion of the tube, and wherein the sensor system implements capacitive sensing.

2. The system of claim 1, wherein the sensor system is curved to correspond to the tube and extends contiguous thereto.

3. The system of claim 1, wherein the sensor system is arranged to overlap one or more longitudinal seams of the tube of packaging material on the filling pipe.

4. The system of claim 1, wherein the sensor system implements an electrode arrangement which is arranged to emit a sensing field over the tube.

5. The system of claim 4, wherein the detection system comprises electrical circuitry to determine the predetermined condition associated with tube integrity from an electrical quantity related to a change in the sensing field caused by the tube.

6. The system of claim 5, wherein the predetermined condition from the electrical quantity is determined based on the electrical quantity crossing one or more thresholds.

7. The system of claim 3, wherein the detection system comprises a mounting assembly arranged to mount the sensor system in operative proximity to the tube, wherein the mounting assembly is connectable to the tube feed machine.

8. The system of claim 1, wherein the predetermined condition associated with tube integrity comprises one or more of:
a degree of tightness of the tube over a sleeve;
a discontinuity in the material of the tube or a longitudinal seam of the tube; and
a determination of a contaminant on the tube.

9. The system of claim 1, comprising electrical circuitry configured to determine the predetermined condition and in response implement one or more of:
a notification to a user interface of the system;
prevent feeding of the tube relative the filling pipe; and
apply an agent to the tube.

10. A packaging unit formed from the system of claim 1.

11. A detection system comprising a sensor system and a mounting assembly for connection to a tube feed machine for execution of a formation process, in which a tube of packaging material is fed along a filling pipe of the tube feed machine and is repetitively processed into individual packaging units.

12. A method of determining integrity of a tube of a tube-feed packaging system, the method comprising:
implementing a tube of packaging material to move along a filling pipe; and
detecting, with the tube on the filling pipe, a predetermined condition associated with tube integrity.

13. Electrical circuitry or a computer program comprising program code executable on one or more processors, of electrical circuitry of a system for formation of tube-feed packaging, to implement the method of claim 12.

14. The system of claim 7, wherein the tube is supported by the filling pipe.
